(19) United States
(12) Patent Application Publication
(10) Pub. No.: US 2026/0247008 A1
(43) Pub. Date: Aug. 20, 2026

(54) ELECTRONIC DEVICE AND METHOD OF LOW VOLTAGE INDICATION

(71) Applicants: Sercomm Corporation, Taipei City (TW); Sernet (Suzhou) Technologies Corporation, Jiangsu (CN)

(72) Inventor: Peng WU, Jiangsu (CN)

(21) Appl. No.: 19/420,963

(22) Filed: Dec. 16, 2025

(30) Foreign Application Priority Data
Feb. 17, 2025 (CN) 202510172331.1

(51) Int. Cl. H04N 21/488; H04N 21/4363

(52) U.S. Cl. CPC H04N 21/4882; H04N 21/43635

(57) ABSTRACT

An aspect of the present disclosure features an electronic device for outputting video. The electronic device includes a SoC configured to generate the video. The electronic device also includes a DC load unit coupled to the SoC. The electronic device also includes a monitoring unit coupled to the SoC and the DC load unit, and configured to detect a load voltage of the DC unit to provide a detection result to the SoC. The electronic device also includes a HDMI port configured to output the video. When the detection result, received by the SoC, is less than a threshold, the SoC outputs a video signal including a low voltage indication through the HDMI port.

### CROOS-REFERENCE TO RELATED APPLICATION(S)

This application claims the benefit of People's Republic of China application Serial No. 202510172331.1, filed February 17, 2025, subject matters of which is incorporated herein by reference.

### TECHNICAL FIELD

The disclosure relates in general to an electronic device for outputting video, and more particularly, to low voltage indication method for electronic device for outputting video.

### BACKGROUND

Currently, set-top boxes used for outputting videos can obtain the power required for their operation through an external power supply or through the own USB connection of TV. However, when the voltage from the external power supply or the power provided by the USB of TV is insufficient, the set-top box may fail to power on or operate properly. In this situation, the user cannot determine the reason why the set-top box cannot power on or operate properly. Thus, there are needs for techniques for low voltage indication in set-top box.

### SUMMARY

The techniques provided by the present disclosure provides a low voltage indication by detecting the input power of a SoC (system on chip) in an electronic device used for outputting videos, such as a set-top box. The indication can be displayed on a monitor via an HDMI port to alert the user to a low voltage condition.

The first aspect of the present disclosure features an electronic device for outputting a video. The electronic device includes a SoC (system on chip) configured to generate the video. The electronic device also includes a DC load unit coupled to the SoC. The electronic device also includes a monitoring unit coupled to the SoC and the DC load unit, and configured to detect a load voltage of the DC unit to provide a detection result to the SoC. The electronic device also includes a HDMI port, coupled to the SoC and configured to output the video. When the detection result, received by the SOC, is less than a threshold, the SOC outputs a video signal including a low voltage indication through the HDMI port.

The second aspect of the present disclosure features a low voltage indication method for an electronic device outputting a video. The low voltage indication method includes detecting, by a monitoring unit of the electronic device, a load of a DC load unit of a SoC of the electronic device and providing a detection result to the SoC. The low voltage indication method also includes, when a load voltage in the detection result received by the SoC is less than a threshold, the SoC outputting a low voltage indication in the video through an HDMI port of the electronic device.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a function block diagram illustrating an electronic device for outputting video, according to some implementations of the present disclosure.

FIG. 2 is a flowchart illustrating a low voltage indication procedure, according to some implementations of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

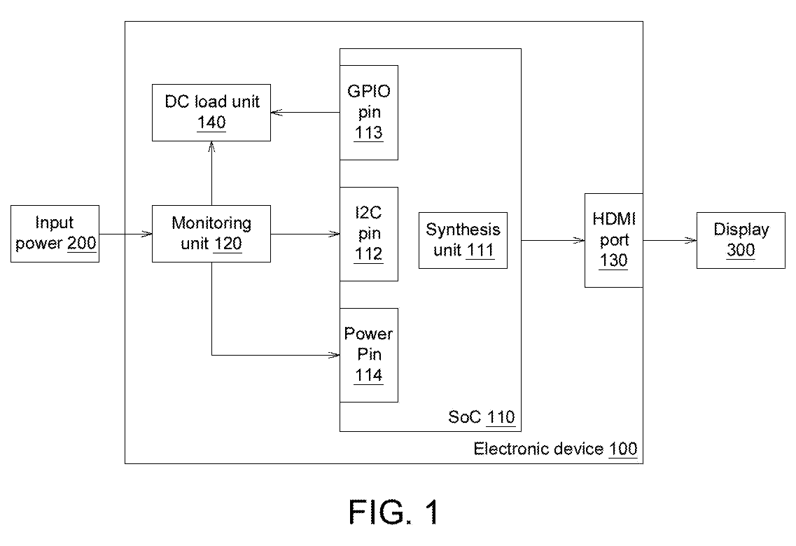

FIG. 1 is a function block diagram illustrating an electronic device 100 for outputting video, according to some implementations of the present disclosure. The electronic device 100 for outputting video, such as a set-top box, includes a SoC 110 for generating video. Specifically, the SoC 110 can execute applications related to video output, such as streaming audio/video or video playback applications, to output related videos to other external devices, such as a display 300. The electronic device 100 also includes a monitoring unit 120 coupled to a power pin 114 and an I2C pin 112 of the SoC 110. The SoC 110 can receive an input power 200 from the monitoring unit 120 through the power pin 114. The electronic device 100 also includes a DC load unit 140, coupled to a GPIO (General Purpose Input/Output) pin 113 of the SoC 110. The DC load unit 140 can be used to simulate loads for testing power supply capacity. The SoC 110 can increase the load (including current) of the DC load unit 140 by adjusting duty cycle or frequency (duty cycle or frequency of the PWM) of a pulse width modulation (PWM) output by the GPIO pin 113. The monitoring unit 120 is coupled to the DC load unit 140 and can be used to detect the load (including current and/or voltage) of the DC load unit 140 and provide a detection result to the SoC 110, for example, by receiving the detection result provided by the monitoring unit 120 through the I2C pin 112. The electronic device 100 also includes an HDMI port 130, which is coupled to the SoC 110 for outputting video generated by the SoC 110, for example to the display 300, so that the display 300 can display the video generated by the SoC 110.

When the SoC 110 receives the input power 200 through the power pin 114 and the monitoring unit 120, the SoC 110 operates its software and powers on. It can adjust the duty cycle or frequency (duty cycle or frequency of the PWM) of its GPIO (General Purpose Input/Output) pin 113 to increase the load (including current) of the DC load unit 140. At the same time, the SoC 110 reads the voltage and/or current values in the load of the DC load unit 140 monitored in real time by the monitoring unit 120 through the I2C pin 112. When the load voltage in the detection result received by the monitoring unit 120 from the SoC 110 is less than a threshold, for example, the threshold can be preset to 4.8V, the SoC 110 can send a low voltage indication through the HDMI port, for example, in the output video, so that the display 300 can display the low voltage indication sent by the SoC 110. In some implementations, when the SoC 110 has been powered on normally and outputting the video to the display 300, if for some reason the load voltage in the detection result received by the monitoring unit 120 from the SoC 110 is less than the threshold, the synthesis unit 111 of the SoC 110 can combine the low voltage indication and the video, and output the low voltage indication and the video to the display 300 through the HDMI port 130, so that the display 300 can display the low voltage indication and the video at the same time. In some implementations, when the load voltage in the detection result received by the monitoring unit 120 from the SoC 110 is not lower than a threshold, it can be determined whether the load current in the load of the DC load unit 140 monitored in real time by the monitoring unit 120 is less than the threshold. The threshold of the load current can be set as needed in the range of 800mA to 1.5A. If the load current of the DC load unit 140 is less than the threshold (such as less than 800mA), the SoC 110 increases the load current of the DC load unit 140 by adjusting the duty cycle or frequency of the pulse width modulation output by its GPIO pin 113. If the load current of the DC load unit 140 is not lower than the threshold, the SoC 110 turns off the DC load unit 140 by adjusting the pulse width modulation output of the GPIO pin 113.

Accordingly, when a user plugs an electronic device, such as a set-top box, into own USB port of a monitor, TV or a lower-specification power supply, or when the power supply malfunctions, the electronic device can automatically detect whether the input power (voltage and/or current) is sufficient, and output a low voltage indication to the monitor or TV via the HDMI port. This allows the user to confirm that the electronic device's inability to power on or operate normally is caused by low voltage (or current), enabling them to perform related operations, such as replacing the power supply.

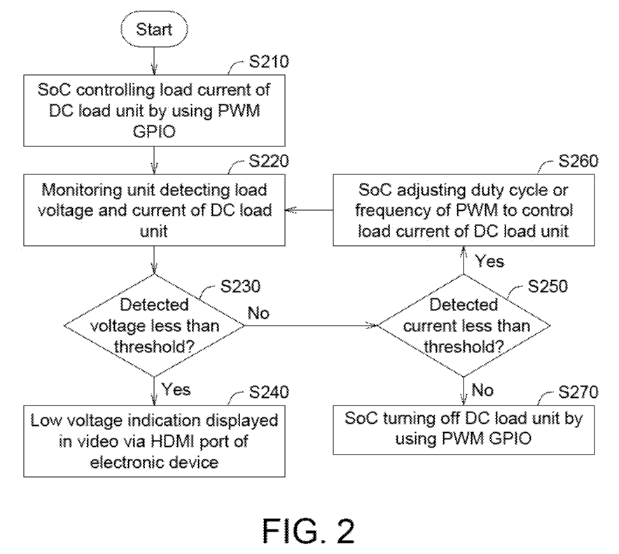

FIG. 2 is a flowchart illustrating a low voltage indication procedure, according to some implementations of the present disclosure. In step S210, the SoC 100 of the electronic device 100 in FIG. 1, for example, control the load current of the DC load unit 140 of the electronic device 100 in FIG. 1, for example, by using PWM.

In step S220, for example, the monitoring unit 120 of the electronic device 100 in FIG. 1 detects the load voltage and current of the DC load unit of the electronic device and provides a detection result to the SoC, such as the SoC 110 in FIG. 1.

In step S230, for example, the SoC 110 of the electronic device 100 determines whether the load voltage in the detection result is less than a threshold. When the load voltage in the detection result is less than the threshold (such as 4.8V), the process proceeds to step S240, where the SoC outputs a video signal including a low voltage indication through the HDMI port of the electronic device, such as the HDMI port 130 in FIG. 1, for example, displayed on the display 300 in FIG. 1.

When the load voltage in the detection result is not less than the threshold (such as 4.8V), proceed to step S250, where the SoC of the electronic device determines whether the load current in the detection result is less than the threshold (the threshold can be set, for example, in the range of 800mA to 1.5A). When the load current in the detection result is less than the threshold (Such as less than 800mA), proceed to step S260, where the SoC adjusts the duty cycle or frequency of the pulse width modulation to increase the load current of the DC load unit, and then returns to step S220. When the detection result is not less than the threshold (such as 4.8V), proceed to step S250, where the SoC of the electronic device determines whether the load current in the detection result is less than the threshold. When the load current in the detection result is not less than the threshold, proceed to step S270, where the SoC adjusts the pulse width modulation to shut down the DC load unit.

In certain configurations, the SoC includes a synthesis unit. When the detection result received by the SoC is less than the threshold, the synthesis unit synthesizes the video and the low voltage indication and outputs the video and the low voltage indication through the HDMI port.

In certain configurations, the SoC receives the detection result from the monitoring unit via an I2C pin.

In certain configurations, the SoC adjusts a load of the DC load unit via a pulse width modulation (PWM) mean through a GPIO pin.

In certain configurations, the SoC adjusts a load current of the DC load unit by adjusting a duty cycle or frequency of the pulse width modulation of the GPIO pin.

A computer program (also known as a program, software, software disclosure, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in a plurality of coordinated files (e.g., files that store one or more modules, sub programs, or portions of code).A computer program can be deployed for execution on one computer or on a plurality of computers that are located at one site or distributed across a plurality of sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors, processing units, engines, and accelerators suitable for the execution of a computer program include, by way of example, both general and special purpose microprocessors, and any one or more processors of any kind of digital computer. Generally, a processor, a processing unit, an engine, or an accelerator will receive instructions and data from a read only memory or a random access memory or both. The essential elements of a computer can include a processor, a processing unit, an engine, or an accelerator for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks. The processor, the processing unit, the engine, or the accelerator and the memory can be supplemented by, or incorporated in, special purpose logic circuitry, such as other processors, processing units, engines, or accelerators.

While this document may describe many specifics, these should not be construed as limitations on the scope of an invention that is claimed or of what may be claimed, but rather as descriptions of features specific to particular implementations. Certain features that are described in this document in the context of separate implementations can also be implemented in combination in a single embodiment. Conversely, various features that are described in the context of a single embodiment can also be implemented in a plurality of implementations separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made according to what is disclosed.

What is claimed is:

1. An electronic device, for outputting a video, comprising:
a SoC (system on chip), configured to generate the video;
a DC load unit, coupled to the SoC;
a monitoring unit, coupled to the SoC and the DC load unit, and configured to detect a load voltage of the DC unit to provide a detection result to the SoC; and
a HDMI port, coupled to the SoC and configured to output the video,
wherein, when the detection result, received by the SOC, is less than a threshold, the SOC outputs a video signal including a low voltage indication through the HDMI port.

2. The electronic device of claim 1, wherein the SoC comprises a synthesis unit,
wherein, when the detection result received by the SoC is less than the threshold, the synthesis unit synthesizes the video and the low voltage indication and outputs the video and the low voltage indication through the HDMI port.

3. The electronic device of claim 1, wherein the SoC receives the detection result from the monitoring unit via an I2C pin.

4. The electronic device of claim 1, wherein the SoC adjusts a load of the DC load unit via a pulse width modulation (PWM) mean through a GPIO pin.

5. The electronic device of claim 4, wherein the SoC adjusts a load current of the DC load unit by adjusting a duty cycle or a frequency of the pulse width modulation of the GPIO pin.

6. A low voltage indication method, for an electronic device outputting a video, comprising:
detecting, by a monitoring unit of the electronic device, a load of a DC load unit of a SoC of the electronic device and providing a detection result to the SoC; and
when a load voltage in the detection result received by the SoC is less than a threshold, the SoC outputting a low voltage indication in the video through an HDMI port of the electronic device.

7. The low voltage indication method claim 6, wherein the SoC comprises a synthesis unit,
wherein, when the detection result received by the SoC is less than the threshold, the synthesis unit synthesizes the video and the low voltage indication and outputs the video and the low voltage indication through the HDMI port.

8. The low voltage indication method claim 6, wherein the SoC receives the detection result from the monitoring unit via an I2C pin.

9. The low voltage indication method claim 6, wherein the SoC adjusts a load of the DC load unit via a pulse width modulation (PWM) mean through a GPIO pin.

10. The low voltage indication method claim 9, wherein the SoC adjusts a load current of the DC load unit by adjusting a duty cycle or a frequency of the pulse width modulation of the GPIO pin.
